(19) United States
(12) Patent Application Publication
(10) Pub. No.: US 2018/0351885 A1
(43) Pub. Date: Dec. 6, 2018

(54) Managing Mute or Snooze Functionality in a Chat Conversation

(71) Applicant: Motorola Mobility LLC, Chicago, IL (US)

(72) Inventors: Amit Kumar Agrawal, Bangalore (IN); Soumya Ranjan Mund, Bangalore (IN)

(73) Assignee: Motorola Mobility LLC, Chicago, IL (US)

(21) Appl. No.: 15/611,409

(22) Filed: Jun. 1, 2017

(51) Int. Cl. H04L 12/58; H04L 12/18

(52) U.S. Cl. CPC H04L 51/043; H04L 12/1822

(57) ABSTRACT

Various embodiments provide a chat management system that provides chat conversation functionality. The chat management system monitors a group chat conversation and automatically places the group chat conversation in mute mode or snooze mode, and automatically places the group chat conversation in an unmute or un-snooze mode based upon various contextual conditions. In one or more embodiments, with respect to automatically placing the group chat conversation in the mute mode or snooze mode, the contextual conditions can include, by way of example and not limitation, the manner in which the user interacts with the chat management system and/or the group chat conversation. In one or more embodiments with respect to automatically placing the group chat conversation in the unmute or un-snooze mode, the contextual conditions can include, by way of example and not limitation, the content of the group chat conversation and predefined or user definable time periods.

### BACKGROUND

Group-based conversations involving multiple users are now a normal part of daily life in both professional and personal contexts. Groups can be created in various messaging applications and allow communication between users across the country and across the globe. Frequently, there are cases where an ongoing conversation interests or otherwise includes a subset of people in the particular group. For example, a group of 20 people may be involved in a group-based chat. At some point, a subset of five people may engage in a conversation that is not of interest to the remaining 15 people. Yet, the remaining 15 people still receive notifications because the subset's conversation is taking place within the group chat. These notifications can be annoying and distracting to people who are not within the subset of five people taking part in the conversation. So, typically, many users will simply manually mute or snooze the chat conversation. If these users forget to unmute or un-snooze the chat conversation, they may potentially miss information that is of interest to them. Needless to say, this is an undesirable, wasteful, and inefficient process.

These and other scenarios continue to pose challenges to those who design communication systems.

### BRIEF DESCRIPTION OF THE DRAWINGS

Embodiments of managing chats, such as group chats, are described with reference to the following Figures. The same numbers may be used throughout to reference like features and components that are shown in the Figures:

FIG. 1 illustrates an operating environment in accordance with one or more embodiments.

FIG. 2 illustrates a computing device in accordance with one or more embodiments.

FIG. 3 is a flow diagram that describes operations in a method in accordance with one or more embodiments.

FIG. 4 illustrates various components of an example device that can implement one or more embodiments.

### DETAILED DESCRIPTION

Overview

The various embodiments described herein provide a chat management system that provides chat conversation functionality. The chat management system monitors a group chat conversation and automatically places the group chat conversation in mute mode or snooze mode, and automatically places the group chat conversation in an unmute or un-snooze mode based upon various contextual conditions. In one or more embodiments, with respect to automatically placing the group chat conversation in the mute mode or snooze mode, the contextual conditions can include, by way of example and not limitation, the manner in which the user interacts with the chat management system and/or the group chat conversation, a user's location, and the like. In one or more embodiments with respect to automatically placing the group chat conversation in the unmute or un-snooze mode, the contextual conditions can include, by way of example and not limitation, the content of the group chat conversation, predefined or user definable time periods, the user's location, and the like.

The various embodiments improve upon the state of the art by managing mute or snooze functionality to automatically select mute or snooze modes, and unmute or un-snooze modes based upon contextual conditions. This relieves the users of having to manually mute group chat conversations and remember to unmute group chat conversations. In this manner, the user experience is improved because the user has less tasks to perform in connection with any particular group chat conversation. Moreover, the possibility of missing content or information that is of interest to the user is greatly reduced because of the context-based, automatic unmute or un-snooze functionality.

In the discussion that follows, an operating environment is described in which the inventive embodiments can be employed. Following this, various embodiments for managing mute or snooze functionality in a chat conversation are described.

Operating Environment

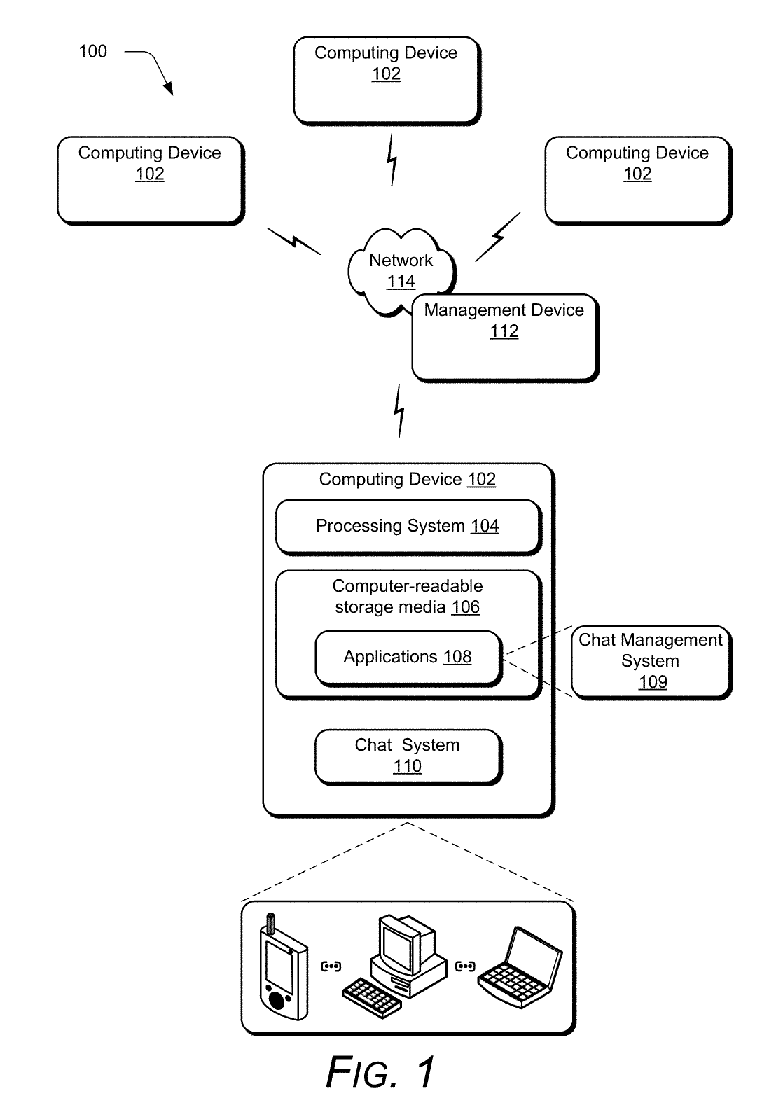

FIG. 1 is an illustration of an environment 100 in an example implementation that is operable to employ techniques described herein. The illustrated environment 100 includes multiple computing devices 102. Each computing device 102 includes, as shown in the bottom-most computing device 102, a processing system 104 that includes one or more processing devices, one or more computer-readable storage media 106, and various applications 108 embodied on the computer-readable storage media 106 and operable via the processing system 104 to implement corresponding functionality described herein. Applications 108 can include a chat management system 109 that is operable to manage calls as described in more detail below. The chat management system 109 can be a standalone application. Alternately, the chat management system 109 can be included as part of another application, plug-in, or system software such as a computing device's operating system. Computing devices 102 also include a chat system 110 that enables a caller to place calls, organize and start group chat sessions, such as voice and video calls/chat sessions, as described above and below. The calls/chat sessions can include Voice over IP (“VoIP”) calls, as well as other calls placed using other different technology.

The computing devices 102 may be configured as any suitable type of computing device. For example, the computing devices may be configured as a television entertainment system, desktop computer, a laptop computer, a mobile device (e.g., assuming a handheld configuration such as a tablet or mobile phone), a tablet, and so forth. Further, the computing devices may be configured as a radiotelephone, a personal communication system (PCS) terminal (e.g., that may combine a cellular radiotelephone with data processing and data communications capabilities), a personal digital assistant (PDA) (e.g., that can include a radiotelephone, a pager, Internet/intranet access, etc.), a wireless device (e.g., a wireless telephone), a cellular telephone, or a smart phone.

Thus, the computing devices 102 may range from full resource devices with substantial memory and processor resources (e.g., television entertainment system, personal computers, game consoles) to a low-resource device with limited memory and/or processing resources (e.g., mobile devices).

Environment 100 also includes a management device 112 and network 114 that enables computing devices 102 to communicate with one another by placing calls, such as voice and video calls by accessing network 114 via management device 112.

Management device 112 may include one or more data transfer devices (or network devices), such as a gateway, a router, a switch, a firewall, a network interface card (NIC), a hub, a bridge, a proxy server, an optical add-drop multiplexer (OADM), or some other type of device that processes, manages, and/or transfers traffic. In one example, management device 112 may include one or more edge devices (e.g., edge routers) that provide entry points into enterprise, carrier, and/or service provider networks.

Network 114 may include a local area network (LAN), a wide area network (WAN), a metropolitan area network (MAN), a telephone network, such as the PSTN, a cellular network, a Wi-Fi network, an intranet, the Internet, an optical fiber (or fiber optic)-based network, an enterprise network, a carrier network, a service provider network, or a combination of networks. In one example implementation, network 114 may include an open network. An open network may include a network of applications, devices, and/or systems that follows industry protocols and thereby create an environment of total interoperability. This means that any new protocol-based products (e.g., for the open network) may automatically be compatible with other compliant products, applications, devices, and/or systems, with no additional programming or interfaces needed.

Having considered an example operating environment, consider now embodiments in which chats can be managed in accordance with one or more embodiments.

Managing Mute or Snooze Functionality in a Chat Conversation

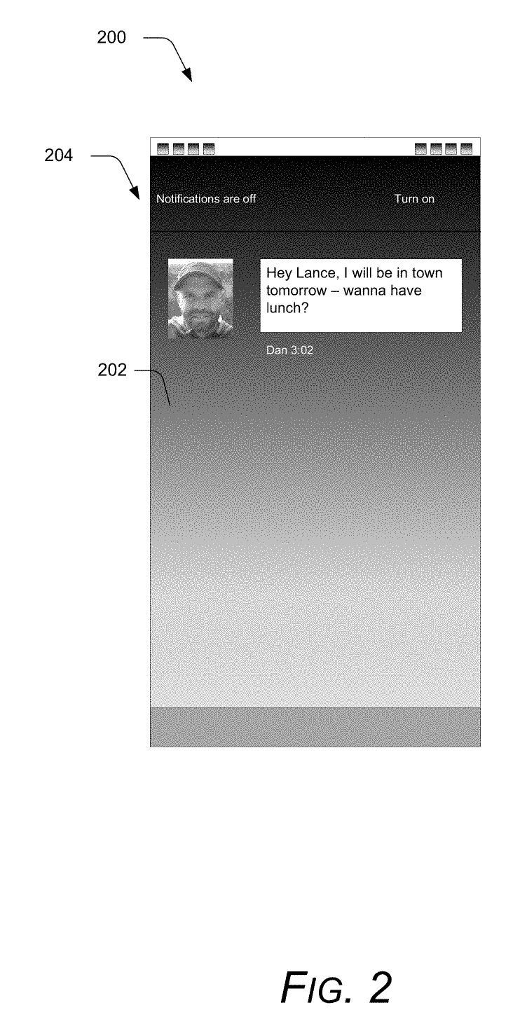

FIG. 2 illustrates a computing device, generally at 200, that includes an application in the form of a chat management system that includes a user interface 202. In this example, a group chat is taking place between a group that includes multiple participants including Lance and Dan. During the course of the group chat, Lance turned his notifications off, as indicated at 204, presumably because the conversation was not of interest to him. In this particular example, however, Lance has forgotten that he turned his notifications off. As a result, Lance will not receive any notifications relative to communications coming into his computing device. By doing so, Lance will miss the message from Dan “Hey Lance, I will be in town tomorrow—wanna have lunch?”

The various embodiments described herein mitigate the problems associated with this scenario, as well as others, by providing a chat management system that provides managed chat conversation functionality in which muting/snoozing and un-muting/snoozing is performed automatically based on various contextual conditions. In some instances, “muting” refers to operations such as turning off the sound so that the device does not create an audible notification (such as a “ding” or similar effect) when a notification is received. In these instances, notifications may be visually surfaced for a user. “Snoozing”, on the other hand, refers to operations which may include not only turning off audible notifications, but turning off visual notifications as well.

To implement the managed chat conversation functionality, the chat management system monitors a group chat conversation and automatically places the group chat conversation in mute mode or snooze mode, and automatically places the group chat conversation in an unmute or un-snooze mode based upon various contextual conditions. In one or more embodiments, with respect to automatically placing the group chat conversation in the mute mode or snooze mode, the contextual conditions can include, by way of example and not limitation, the manner in which the user interacts with the chat management system and/or the group chat conversation, a user's location and the like. In one or more embodiments with respect to automatically placing the group chat conversation in the unmute or un-snooze mode, the contextual conditions can include, by way of example and not limitation, the content of the group chat conversation, predefined or user definable time periods, the user's location, and the like.

Consider now examples of automatically placing the group chat conversation in the mute mode or snooze mode.

Automatically Muting or Snoozing a Group Chat Conversation

In one or more embodiments, with respect to automatically placing the group chat conversation in the mute mode or snooze mode, the contextual conditions can include, by way of example and not limitation, the manner in which the user interacts with the chat management system and/or the group chat conversation, the user's location, and the like. As an example, consider the following.

In one or more embodiments, when a user participating in a group chat conversation dismisses notifications associated with the conversation, the chat management system can ascertain that the user does not have an interest in the conversation. The chat management system can ascertain this in a number of different ways. For example, if the user dismisses at least one notification and/or dismisses a notification immediately, e.g., within less than one or two seconds, the chat management system can ascertain that the user does not have an interest in the conversation. Alternately or additionally, if the user dismisses multiple notifications and continues to dismiss notifications, the chat management system can ascertain that the user does not have an interest in the conversation. Thus, the chat management system can monitor the user's notification dismissal behavior and, based upon the user's behavior, the chat management system can make an assumption with respect to whether the user is interested in a conversation or not. If the chat management system ascertains that the user is not interested in the conversation based upon the user's notification dismissal behavior, then the chat management system can automatically mute or snooze the group chat.

In one or more embodiments, if the user's device receives a notification, such as an audible notification, and the user places their device in a silent mode or otherwise reduces the volume setting, the chat management system can ascertain that the user does not have an interest in the group chat conversation. Accordingly, the chat management system can then automatically mute or snooze the group chat.

In at least some embodiments, when the conversation in a group chat belongs to specific participants of the group for a threshold period of time or a threshold number of chat communications which does not involve a particular user, the chat management system can ascertain that the user does not have an interest in the group chat conversation. Accordingly, the chat management system can then automatically mute or snooze the group chat. In this manner, the user's lack of communication with the group chat conversation is deemed by the chat management system as a lack of interaction from which an assumption can be made that the user does not have an interest in the conversation.

In at least some embodiments, a user's location can be used as a contextual condition to automatically place the group chat conversation in the mute mode or snooze mode. For example, a user may travel to a temporary location for a work-related matter. While at the temporary location, the user may participate in group chats associated with a particular location-specific project. Upon returning to their permanent location, the group chats associated with the temporary location may not have any relevance to the user. Accordingly, in at least some embodiments, the chat management system can ascertain that a user's location has changed and can automatically place group chat conversations associated with the temporary location in the mute mode or snooze mode.

Having considered how a group chat conversation can be muted or snoozed automatically, consider now examples of automatically placing the group chat conversation in the unmute or un-snooze mode.

Automatically Unmuting or Un-Snoozing a Group Chat Conversation

In one or more embodiments with respect to automatically placing the group chat conversation in the unmute or un-snooze mode, the contextual conditions can include, by way of example and not limitation, the content of the group chat conversation, predefined or user definable time periods, the user's location and the like. As an example, consider the following.

In one or more embodiments, when a group chat conversation has been muted or snoozed, and the user is referred to in the conversation, the chat management system can automatically unmute or un-snooze the group chat conversation. To do so, the chat management system can monitor the conversation, such as by using voice recognition software, to ascertain if the user's name is mentioned by other participants in the group chat conversation. This particular functionality is based upon an assumption that when a user's name is mentioned, the user will likely have an interest in the conversation.

In one or more other embodiments, the chat management system can utilize a predefined time period, such as 5 or 10 minutes, and can automatically unmute or un-snooze the group chat conversation after expiration of the predefined time period. Alternately or additionally, the chat management system may provide the user with an opportunity to define the length of the time period. So, for example, a user interface instrumentality may be presented to the user to enable the user to define the length of the time period that the group chat conversation is to be muted or snoozed.

In at least some embodiments, the chat management system can monitor the group chat conversation and can ascertain when the context of the conversation changes. When the context of the conversation changes, the chat management system can automatically unmute or un-snooze the group chat conversation. The context of the conversation can change in various different ways. For example, in some embodiments, the chat management system can monitor the content of the conversation and, based upon the content, the chat management system can ascertain that the topic of the conversation has changed. For example, the chat management system can monitor a conversation for keywords that pertain to the current topic. Keywords may include words such as proper names, nouns, actions, and the like. Keywords may also include certain types of transitional phrases such as “Let's talk about . . . ”, “Moving on now . . . ”, “The next item is . . . ” and the like.

In at least some embodiments, a user's location can be used as a contextual condition to automatically place the group chat conversation in the unmute mode or un-snooze mode. For example, a user may travel to a temporary location for a work-related matter. While at the temporary location, the user may participate in group chats associated with a particular location-specific project. Upon returning to their permanent location, the group chats associated with the temporary location may not have any relevance to the user. Accordingly, in at least some embodiments, the chat management system can ascertain that a user's location has changed and can automatically place group chat conversations associated with the temporary location in the mute mode or snooze mode. Now, a user may travel from their permanent location back to the temporary location. When the chat management system detects that the user has returned back to the temporary location, the chat management system can unmute or un-snooze the group chat conversation.

Having considered various embodiments in which a group chat conversation can be automatically unmuted or un-snoozed, consider now an example method in accordance with one or more embodiments.

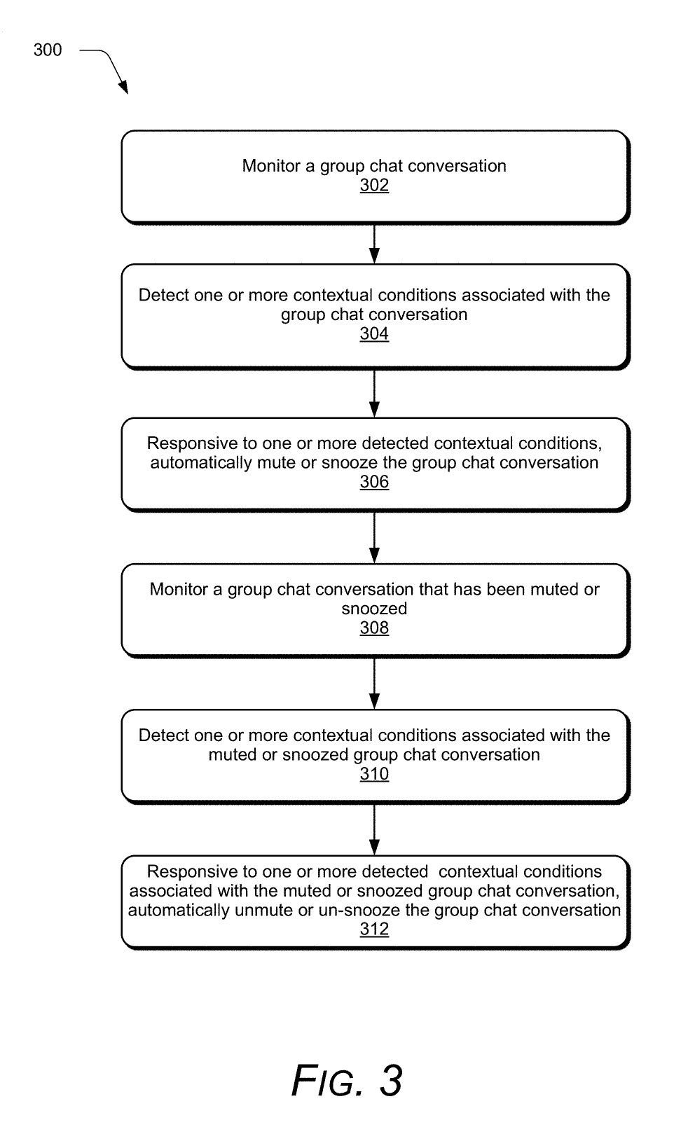

Example method 300 is described with reference to FIG. 3. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method 300 of managing mute or snooze functionality in a group chat conversation. The order in which the method is described is not intended to be construed as a limitation, and any number or combination of the described method operations can be performed in any order to perform a method, or an alternate method.

At block 302, the chat management system monitors a group chat conversation. This operation can be performed in any suitable way. At block 304, the chat management system detects one or more contextual conditions associated with the group chat conversation. Examples of how this can be done are provided above. Responsive to one or more detected contextual conditions, the chat management system automatically mutes or snoozes the group chat conversation at 306.

When a group chat conversation has been muted or snoozed, either automatically by the chat management system or manually by the user, the chat management system can monitor the group chat conversation that has been muted or snooze at block 308. At block 310, the chat management system detects one or more contextual conditions associated with the muted or snoozed group chat conversation. At block 312, responsive to one or more detected contextual conditions associated with the muted or snoozed group chat conversation, the chat management system automatically unmutes or un-snoozes the group chat conversation.

The various embodiments described above improve upon the state of the art by managing mute or snooze functionality to automatically select mute or snooze modes, and unmute or un-snooze modes based upon contextual conditions. This relieves the users of having to manually mute group chat conversations and remember to unmute group chat conversations. In this manner, the user experience is improved because the user has less tasks to perform in connection with any particular group chat conversation. Moreover, the possibility of missing content or information that is of interest to the user is greatly reduced because of the context-based, automatic unmute or un-snooze functionality.

Having considered various embodiments described above, consider now an example device that can be utilized to implement the described embodiments.

### Example Device

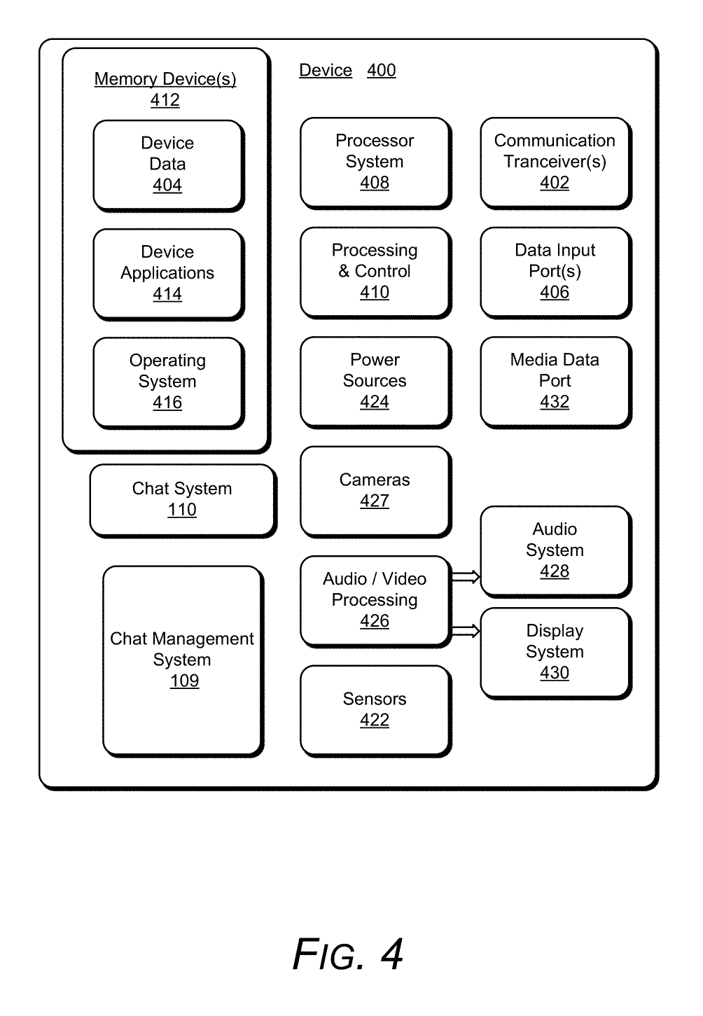

FIG. 4 illustrates various components of an example device 400 in which embodiments of managing calls can be implemented. The example device 400 can be implemented as any of the devices described with reference to the previous figures, such as any type of client device, mobile phone, tablet, computing, communication, entertainment, gaming, media playback, and/or other type of electronic device.

The device 400 includes communication transceivers 402 that enable wired and/or wireless communication of device data 404 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 400 may also include one or more data input ports 406 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 400 includes a processing system 408 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternately or in addition, the device can be implemented with any one or combination of software, hardware, firmware, or fixed logic circuitry that is implemented in connection with processing and control circuits, which are generally identified at 410. The device 400 may further include any type of a system bus or other data and command transfer system that couples the various components within the device. A system bus can include any one or combination of different bus structures and architectures, as well as control and data lines.

The device 400 also includes computer-readable storage memory 412 that enable data storage, such as data storage devices that can be accessed by a computing device, and that provide persistent storage of data and executable instructions (e.g., software applications, programs, functions, and the like). Examples of the computer-readable storage memory 412 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 400 may also include a mass storage media device.

The computer-readable storage memory 412 provides data storage mechanisms to store the device data 404, other types of information and/or data, and various device applications 414 (e.g., software applications). For example, an operating system 416 can be maintained as software instructions with a memory device and executed by the processing system 408. The device applications may also include a device manager, such as any form of a control application, software application, signal-processing and control module, code that is native to a particular device, a hardware abstraction layer for a particular device, and so on.

In addition, device 400 can include chat system 110 and chat management system 109 that operates as described above and below. The chat system 110 and chat management system 109 can be implemented in any suitable hardware, software, firmware or combination thereof.

The device 400 can also include one or more device sensors 422, such as any one or more of an ambient light sensor, a proximity sensor, a touch sensor, an infrared (IR) sensor, accelerometer, gyroscope, and the like. The device 400 can also include one or more power sources 424, such as when the device is implemented as a mobile device. The power sources may include a charging and/or power system, and can be implemented as a flexible strip battery, a rechargeable battery, a charged super-capacitor, and/or any other type of active or passive power source.

The device 400 also includes an audio and/or video processing system 426 that generates audio data for an audio system 428 and/or generates display data for a display system 430, and multiple cameras 427. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 432. In implementations, the audio system and/or the display system are integrated components of the example device. Alternatively, the audio system and/or the display system are external, peripheral components to the example device.

Although the embodiments described above have been described in language specific to features and/or methods, the subject of the appended claims is not necessarily limited to the specific features or methods described. Rather, the specific features and methods are disclosed as example implementations, and other equivalent features and methods are intended to be within the scope of the appended claims. Further, various different embodiments are described and it is to be appreciated that each described embodiment can be implemented independently or in connection with one or more other described embodiments.

The invention claimed is:

1. A method, comprising:
monitoring, using a chat management system, a group chat conversation;
detecting, using the chat management system, one or more contextual conditions associated with the group chat conversation; and
responsive to one or more detected contextual conditions, automatically muting or snoozing, using the chat management system, the group chat conversation.

2. The method as recited in claim 1, wherein said one or more contextual conditions comprise a manner in which a user interacts with the chat management system.

3. The method as recited in claim 1, wherein said one or more contextual conditions comprise a manner in which a user interacts with the group chat conversation.

4. The method as recited in claim 1, wherein said one or more contextual conditions comprise a user's notification dismissal behavior.

5. The method as recited in claim 1, wherein said one or more contextual conditions comprise receiving a notification and then detecting that a user placed a corresponding device in a silent mode or reduced a volume setting.

6. The method as recited in claim 1, wherein said one or more contextual conditions comprise a threshold number of chat communications that does not involve a particular user.

7. The method as recited in claim 1, wherein said one or more contextual conditions comprise a threshold period of time in which chat communications do not involve a particular user.

8. The method as recited in claim 1 further comprising:
monitoring the group chat conversation that has been muted or snoozed;
detecting one or more contextual conditions associated with the muted or snoozed group chat conversation; and
responsive to detecting one or more contextual conditions associated with the muted or snoozed group chat conversation, automatically unmuting or un-snoozing the group chat conversation.

9. The method as recited in claim 8, wherein said one or more contextual conditions associated with the muted or snoozed group chat conversation comprise a user's name being mentioned by other participants in the group chat conversation.

10. The method as recited in claim 1, wherein said one or more contextual conditions associated with the muted or snoozed group chat conversation comprise a time period in which the group chat conversation has been muted or snoozed.

11. The method as recited in claim 1, wherein said one or more contextual conditions associated with the muted or snoozed group chat conversation comprise when context of the group chat conversation changes.

12. One or more computer readable media storing computer-readable instructions which, when executed, perform operations comprising:
monitoring a group chat conversation that has been muted or snoozed;
detecting one or more contextual conditions associated with the muted or snoozed group chat conversation; and
responsive to detecting one or more contextual conditions associated with the muted or snoozed group chat conversation, automatically unmuting or un-snoozing the group chat conversation.

13. The one or more computer readable media as recited in claim 12, wherein said one or more contextual conditions associated with the muted or snoozed group chat conversation comprise a user's name being mentioned by other participants in the group chat conversation.

14. The one or more computer readable media as recited in claim 12, wherein said one or more contextual conditions associated with the muted or snoozed group chat conversation comprise a time period in which the group chat conversation has been muted or snoozed.

15. The one or more computer readable media as recited in claim 12, wherein said one or more contextual conditions associated with the muted or snoozed group chat conversation comprise when context of the group chat conversation changes.

16. A computing device comprising:
one or more processors; and
one or more computer readable media storing computer-readable instructions which, when executed, perform operations comprising:
monitoring, using a chat management system, a group chat conversation;
detecting, using the chat management system, one or more contextual conditions associated with the group chat conversation; and
responsive to one or more detected contextual conditions, automatically muting or snoozing, using the chat management system, the group chat conversation.

17. The computing device as recited in claim 17, wherein said one or more contextual conditions comprise one or more of: a user's notification dismissal behavior; receiving a notification and then detecting that a user placed a corresponding device in a silent mode or reduced a volume setting; a threshold number of chat communications that does not involve a particular user; or a threshold period of time in which chat communications do not involve a particular user.

18. The computing device as recited in claim 17 further comprising:
monitoring the group chat conversation that has been muted or snoozed;
detecting one or more contextual conditions associated with the muted or snoozed group chat conversation; and
responsive to detecting one or more contextual conditions associated with the muted or snoozed group chat conversation, automatically unmuting or un-snoozing the group chat conversation.

19. The computing device as recited in claim 18, wherein said one or more contextual conditions associated with the muted or snoozed group chat conversation comprise a user's name being mentioned by other participants in the group chat conversation.

20. The computing device as recited in claim 18, wherein said one or more contextual conditions associated with the muted or snoozed group chat conversation comprise a time period in which the group chat conversation has been muted or snoozed.
